(19) United States
(12) Patent Application Publication
(10) Pub. No.: US 2026/0284924 A1
(43) Pub. Date: Sep. 24, 2026

(54) VERTICAL CLAMPING DEVICE FOR CIRCULAR SAW MACHINES

(71) Applicant: Hui-Chuan LIAO, Oakland, CA (US)

(72) Inventors: Hui-Chuan LIAO, Oakland, CA (US); Jia-Rong LYU, Taichung City (TW); Yu-Chen HSIAO, Taichung City (TW); Chun-Ti WANG, Taichung City (TW)

(73) Assignee: Hui-Chuan LIAO, Oakland, CA (US)

(21) Appl. No.: 19/082,775

(22) Filed: Mar. 18, 2025

(51) Int. Cl. B27B 9/04

(52) U.S. Cl. CPC B27B 9/04

(57) ABSTRACT

A vertical clamping device for circular saw machines has a body, a connector, and an operating button. The body has a first direction, a top abutting plate, and a side abutting plate. The side abutting plate is connected to the top abutting plate along the first direction such that the side abutting plate is perpendicular to the top abutting plate. The connector is detachably connected to the body and has a second direction perpendicular to the first direction, a connecting recess, and a connecting block. The connecting recess is formed through the connector and is mounted on the body. The connecting block is disposed on a side of the connector and has a connecting rail formed on and protruded from the connecting block and extending along the second direction. The operating button is rotatably connected to the connector and has an engaging element extending below the connecting block.

### BACKGROUND OF THE INVENTION

### 1. Field of the Invention

The present invention relates to a vertical clamping device, and more particularly to a vertical clamping device for circular saw machines that can be assembled conveniently, can reduce manufacturing costs, and can accurately perform vertical cutting.

### 2. Description of Related Art

A conventional power saw is a handheld rotary cutting machine equipped with a toothed disc or a grinding wheel. The toothed disc or the grinding wheel is driven to rotate to cut a board. The conventional power saws generally include circular saw machines and track saw machines. When the circular saw machine is used to perform vertical cutting on a board, in order to ensure the accuracy and quality of the cutting, it must be used with a square to ensure that the cutting direction is perpendicular to the board. When the track saw machine is used to perform vertical cutting on a board, since the size of the track of the track saw machine is large, it cannot be used with the square and must be used with a conventional clamping device so that the track of the track saw machine can be accurately set on the board. Then the cutting direction of the track saw machine can be kept perpendicular to the board when cutting the board. Furthermore, in use, the conventional clamping device secures the position of the track relative to the board by abutting against the side or the bottom of the track.

Although the conventional clamping device can be used to position the track of the track saw machine to provide the effect of ensuring the cutting direction, the conventional clamping device can only position the track by abutting against the side or the bottom of the track. However, a single-direction abutment method (side or bottom) cannot be effectively corrected and positioned, and is prone to geometric tolerances, which not only affects the processing accuracy of vertical cutting, but also requires repeated correction and positioning to ensure processing accuracy, which relatively increases the inconvenience and time required for assembly. In addition, the conventional clamping device needs to be provided with a clamper or fastener that can clamp the track, and a computer numerical control (CNC) processing is required to manufacture and control the accuracy of the conventional clamping device, which relatively increases the cost required for manufacturing. In view of this, since the conventional clamping device for the track saw machine has the above-mentioned problems and shortcomings, the conventional clamping device needs to improve.

The vertical clamping device for circular saw machines in accordance with the present invention mitigates or obviates the aforementioned problems.

### SUMMARY OF THE INVENTION

The main objective of the present invention is to provide a vertical clamping device for circular saw machines that can be assembled conveniently, can reduce manufacturing costs, and can accurately perform vertical cutting.

The vertical clamping device for circular saw machines in accordance with the present invention has a body, a connector, and an operating button. The body has a first direction, a top abutting plate, and a side abutting plate. The side abutting plate is connected to the top abutting plate along the first direction such that the side abutting plate is perpendicular to the top abutting plate. The connector is detachably connected to the body and has a second direction perpendicular to the first direction, a connecting recess, and a connecting block. The connecting recess is formed through a bottom of the connector and is mounted on an end of the body. The connecting block is disposed on a side of the connector at a side of the connecting recess away from the body, and has a connecting rail formed on and protruded from a bottom of the connecting block and extending along the second direction of the connector. The operating button is rotatably connected to the connector and has an engaging element extending below the connecting block.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a vertical clamping device for circular saw machines in accordance with the present invention;

FIG. 2 is another perspective view of the vertical clamping device for circular saw machines in FIG. 1;

FIG. 3 is an exploded perspective view of the vertical clamping device for circular saw machines in FIG. 1;

FIG. 4 is another exploded perspective view of the vertical clamping device for circular saw machines in FIG. 1;

FIG. 5 is a side view in partial section of the vertical clamping device for circular saw machines in FIG. 1;

FIG. 6 is an operational perspective view of the vertical clamping device for circular saw machines in FIG. 1, mounted between a board and a straight edge tool;

FIG. 7 is an enlarged and operational perspective view of the vertical clamping device for circular saw machines in FIG. 6;

FIG. 8 is an enlarged side view in partial section of the vertical clamping device for circular saw machines in FIG. 7;

FIG. 8A is an enlarged cross-sectional side view of the vertical clamping device for circular saw machines in FIG. 8;

FIG. 9 is a partial exploded perspective view of a second embodiment of a vertical clamping device for circular saw machines in accordance with the present invention;

FIG. 10 is a partial exploded perspective view of a third embodiment of a vertical clamping device for circular saw machines in accordance with the present invention; and

FIG. 11 is a partial exploded perspective view of a fourth embodiment of a vertical clamping device for circular saw machines in accordance with the present invention.

### DETAILED DESCRIPTION OF THE PREFERRED EMBODIMENT

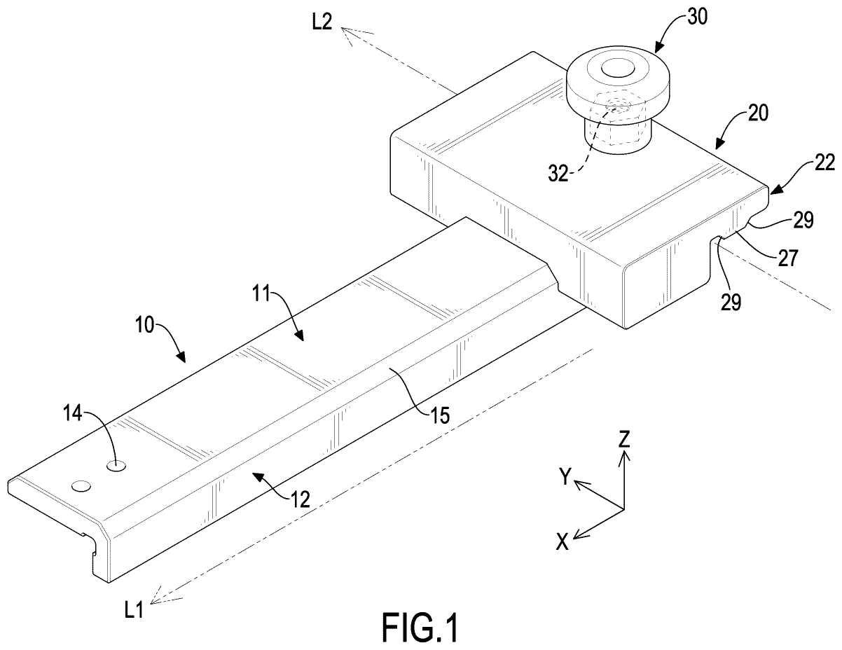

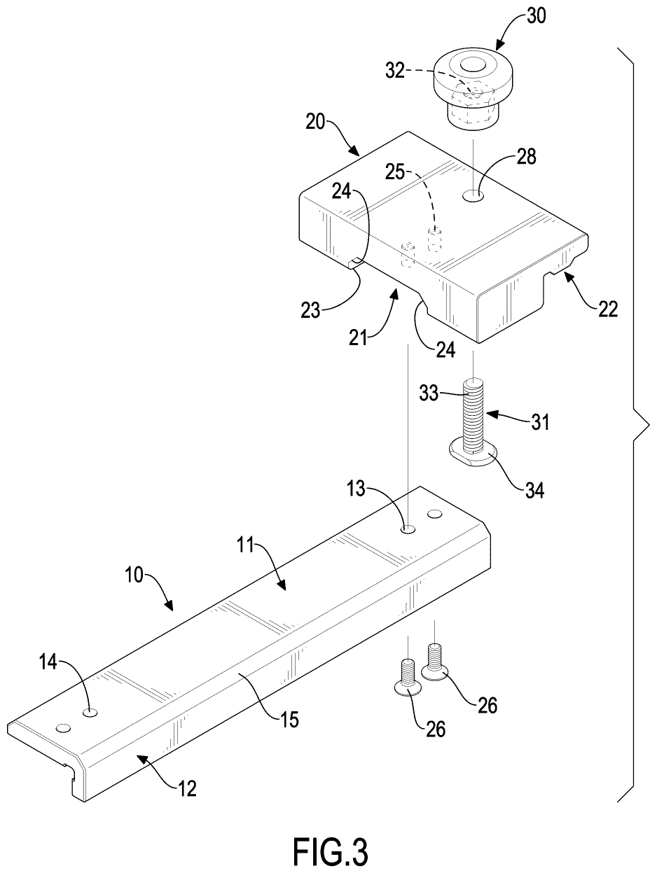

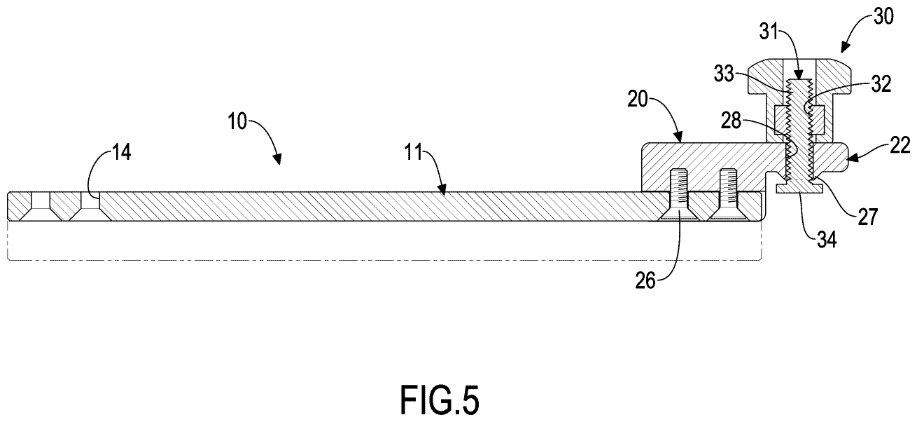

With reference to FIGS. 1 to 5, a first embodiment of a vertical clamping device for circular saw machines in accordance with the present invention has a body 10, a connector 20, and an operating button 30.

With reference to FIGS. 1 to 4, the body 10 is a strip-shaped body made by aluminum extrusion, and has a first direction L1 extending along a length direction of the body 10. With reference to FIG. 1, the first direction L1 of the body 10 may be parallel to the X-axis direction. The body 10 has a cross section along the first direction L1 being L-shaped, so that the body 10 has a top abutting plate 11 and a side abutting plate 12. The top abutting plate 11 extends along the first direction L1 and has at least one first through hole 13 and at least one second through hole 14. The at least one first through hole 13 is formed through a top side and a bottom side of the top abutting plate 11 adjacent to one of two ends of the top abutting plate 11. The at least one second through hole 14 is formed through the top side and the bottom side of the top abutting plate 11 adjacent to the other one of the two ends of the top abutting plate 11. Preferably, the top abutting plate 11 has multiple said first through holes 13 formed through the first abutting plate 11 at spaced intervals at the corresponding end of the first abutting plate 11, and multiple said second through holes 14 formed through the first abutting plate 11 at spaced intervals at the corresponding end of the first abutting plate 11. The side abutting plate 12 is connected to a side face of the top abutting plate 11 along the first direction L1 such that an inner side of the side abutting plate 12 is perpendicular to the bottom side of the top abutting plate 11. Additionally, the body 10 has two positioning faces 15 inclinedly and respectively formed on two edges of the top abutting plate 11 along the first direction L1.

With reference to FIGS. 1 to 4, the connector 20 is a block made by aluminum extrusion, is detachably connected to the body 10, and has a second direction L2 extending along a length direction of the connector 20. With reference to FIG. 1, the second direction L2 of the connector 20 may be parallel to the Y-axis direction, and is perpendicular to the first direction L1. The connector 20 has a connecting recess 21 and a connecting block 22. The connecting recess 21 is formed through the bottom of the connector 20 along a direction parallel to the first direction L1, so that an extending direction of the connecting recess 21 is perpendicular to the second direction L2. The connecting recess 21 has an opening 23 facing the top abutting plate 11 of the body 10 and two limiting faces 24 respectively disposed at two corners of an inner side of the connecting recess 21 away from the opening 23. When the connector 20 is connected to the body 10 via the connecting recess 21, the two limiting faces 24 are respectively abutted against the two positioning faces 15 of the body 10, so that the connector 20 can be accurately disposed on the body 10, thereby ensuring that the second direction L2 is perpendicular to the first direction L1. The connecting recess 21 has at least one fixing hole 25 and at least one fastener 26. The at least one fixing hole 25 is formed in the inner side of the connecting recess 21 and selectively aligns with the at least one first through hole 13 and the at least one second through hole 14. The at least one fastener 26 is connected to the at least one fixing hole 25 via the at least one first through hole 13 or the at least one second through hole 14 to connect the connector 20 securely on the body 10. Preferably, the connector 20 is provided with fixing holes 25 and fasteners 26 in the same number as the first through holes 13 and the second through holes 14.

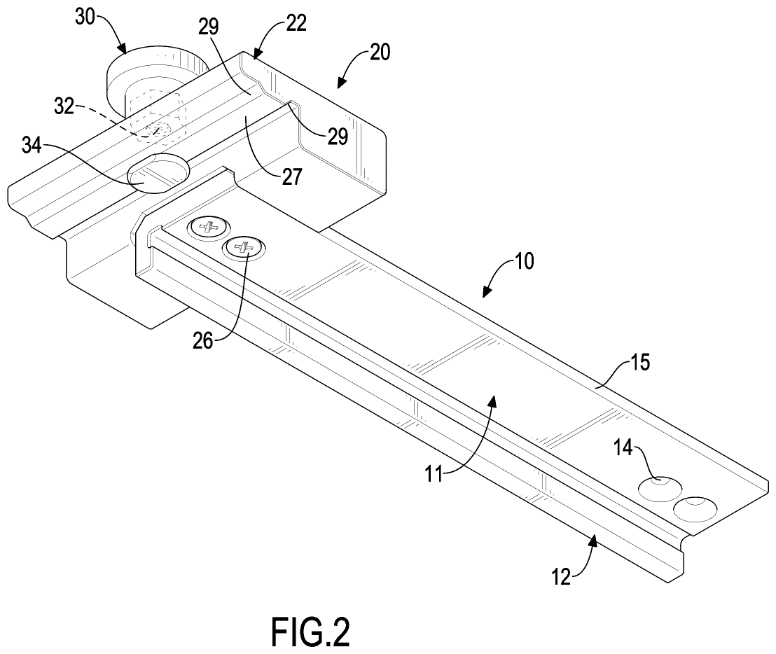

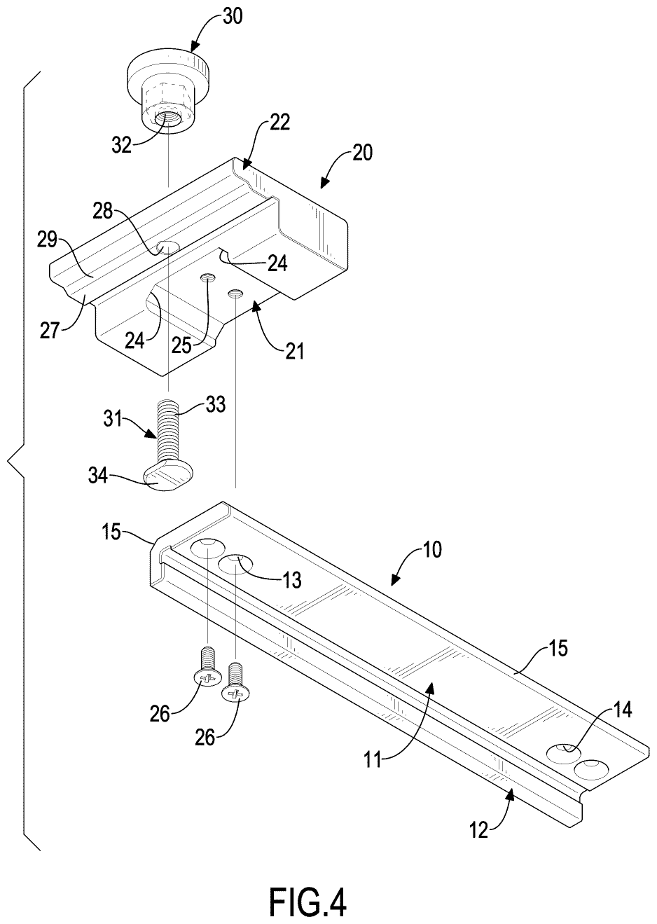

With reference to FIGS. 2 and 4, the connecting block 22 is disposed on a side of the connector 20 at a side of the connecting recess 21 away from the body 10, and has a connecting rail 27 and a via hole 28. The connecting rail 27 is formed on and protrudes from a bottom of the connecting block 22 and extends along the second direction L2. Furthermore, the connecting rail 27 has two guiding inclined faces 29 respectively formed on two sides of the connecting rail 27 along the second direction L2. The via hole 28 is longitudinally formed through the connecting block 22 and the connecting rail 27.

With reference to FIGS. 1 to 4, the operating button 30 is rotatably connected to the connector 20 at the via hole 28 of the connecting block 22, and has an engaging element 31. The engaging element 31 extends below the connecting block 22 via the via hole 28. Furthermore, the operating button 30 has a screw hole 32 formed therein, and the engaging element 31 has a threaded rod 33 and an engaging unit 34. The threaded rod 33 is screwed with the screw hole 32 of the operating button 30 via the via hole 28, and the engaging unit 34 is connected to an end of the threaded rod 33 away from the operating button and is disposed below the connecting block 22. Furthermore, in another embodiment, the threaded rod 33 is formed in and extends out of the operating button 30 and extends below the connecting block 22 via the via hole 28, and the engaging element 31 is an engaging block and is connected to the threaded rod 33.

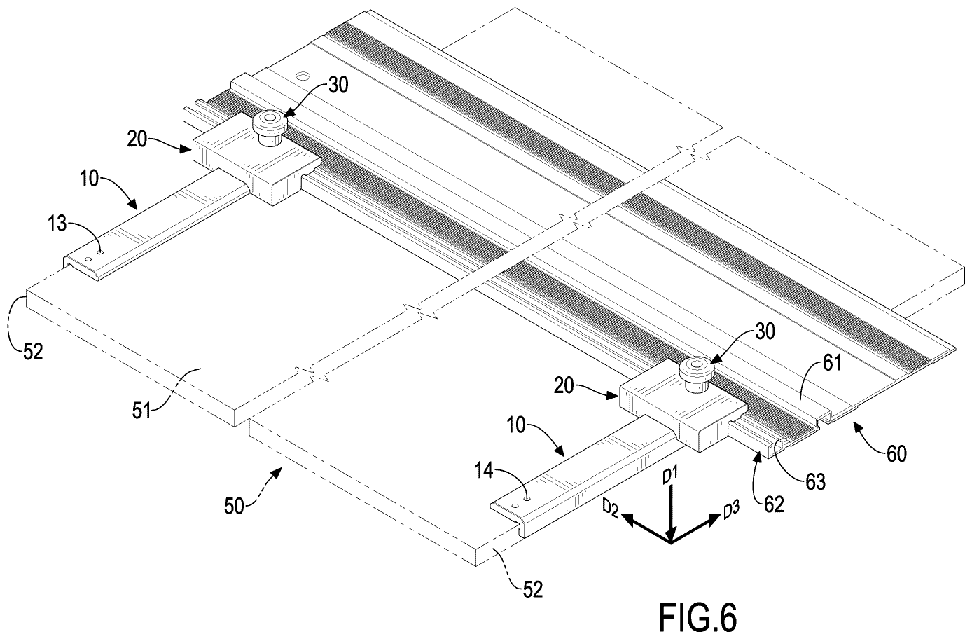

With reference to FIGS. 6, 7, 8, and 8A, when the first embodiment of the vertical clamping device for circular saw machines of the present invention is in use, firstly, a guide rail panel 60 for setting up a circular saw machine is arranged on a board 50 to be processed, and the guide rail panel 60 has a rail 61 formed on and protruded from a top surface of the guide rail panel 60 and extending along a length direction of the guide rail panel 60. The rail 61 is used for linear guidance when the circular saw machine moves relative to the guide rail panel 60 and the board 50. The guide rail panel 60 has a track 62 parallel to and disposed beside the rail 61 in the length direction of the guide rail panel 60. The track 62 has an opening 63 disposed upwardly.

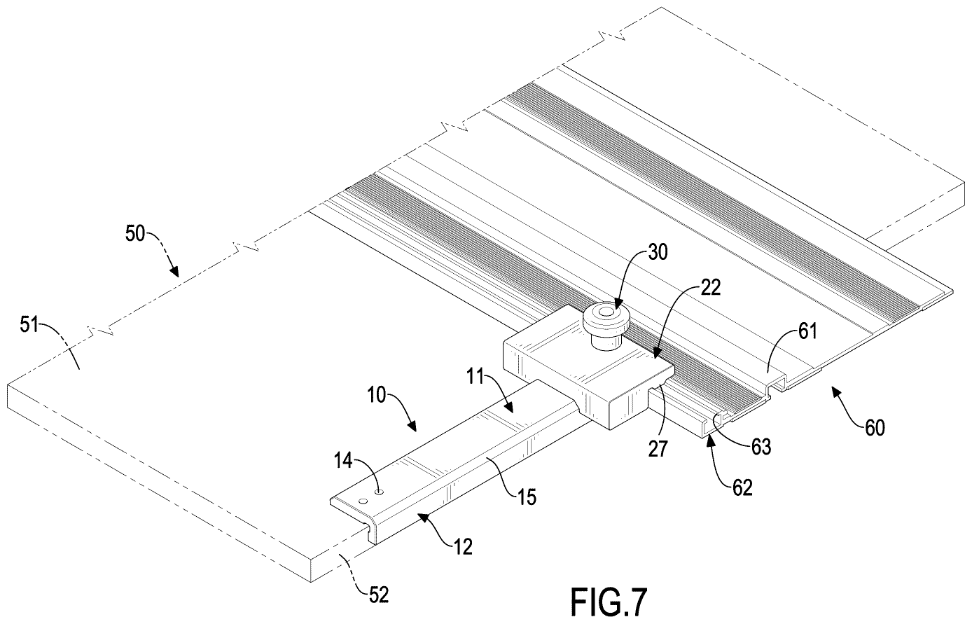

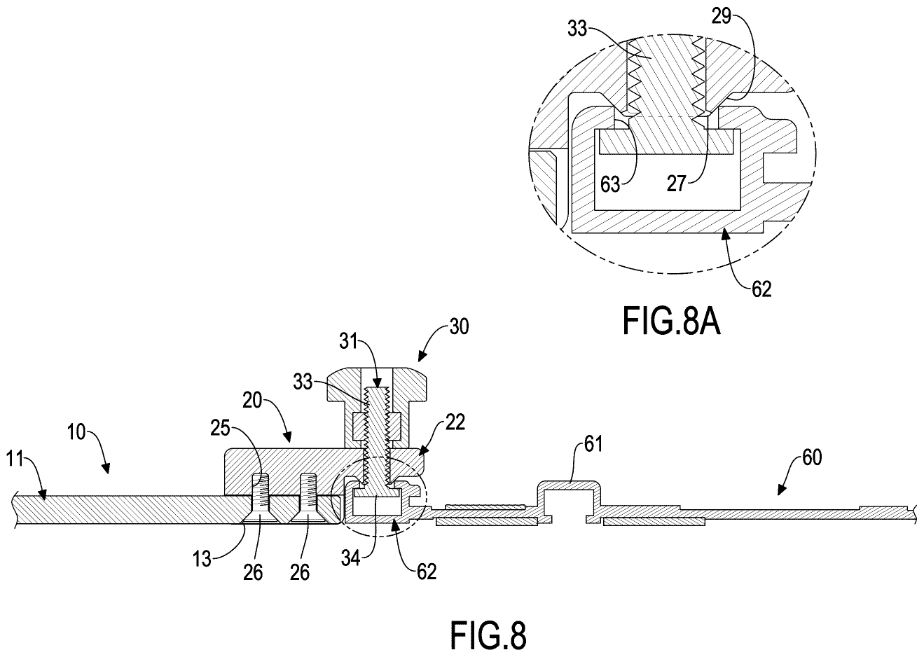

At this time, the first embodiment of the vertical clamping device for circular saw machines of the present invention is disposed on a side of the board 50 and on a side of the guide rail panel 60 that forms the track 62. The body 10 is pushed to move toward the board 50 to enable the bottom side of the top abutting plate 11 to abut against a top surface 51 of the board 50, and to enable the inner side of the side abutting plate 12 to abut against a side surface 52 of the board 50. Then, abutment and positioning are formed in two directions, i.e., a first abutting direction D1 and a second abutting direction D2 as shown in FIG. 6. The connector 20 disposed on the body 20 is moved toward the track 62 of the guide rail panel 60, and the engaging unit 34 of the engaging element 31 of the operating button 30 extends into the track 62 via the opening 63 of the track 62. With reference to FIGS. 7, 8, and 8A, the operating button 30 is rotated relative to the connector 20, and the screw hole 32 and the threaded rod 33 are relatively screwed and moved, so that the engaging unit 34 engages with the track 62. The connecting rail 27 is located at the opening 63 of the track 62 and is parallel to the track 62, and the connecting block 21 is abutted against the corresponding side of the guide rail panel 60, thereby forming a positioning effect in a third direction, i.e., a third abutting direction D3 as shown in FIG. 6. In addition, the two guiding inclined faces 29 on the two sides of the connecting rail 27 can absorb the width gap error between the connecting rail 27 and the opening 63 of the track 62 by the slopes of the two guiding inclined faces 29, and limit the horizontal freedom, so that the connector 20 and the track 62 maintain a parallel relationship.

Furthermore, with reference to FIG. 6, similar to the above-mentioned operation method, a vertical clamping device for circular saw machines of the present invention is set on the other side of the board 50, and the only difference is that the connector 20 is located on one end of the body 10 where the at least one second through hole 14 is set. By connecting the two vertical clamping devices with the guide rail panel 60, it can be ensured that the rail 61 and the board 50 are perpendicular to each other, so that the circular saw machine moving along the rail 61 can accurately cut a vertical surface on the board 50.

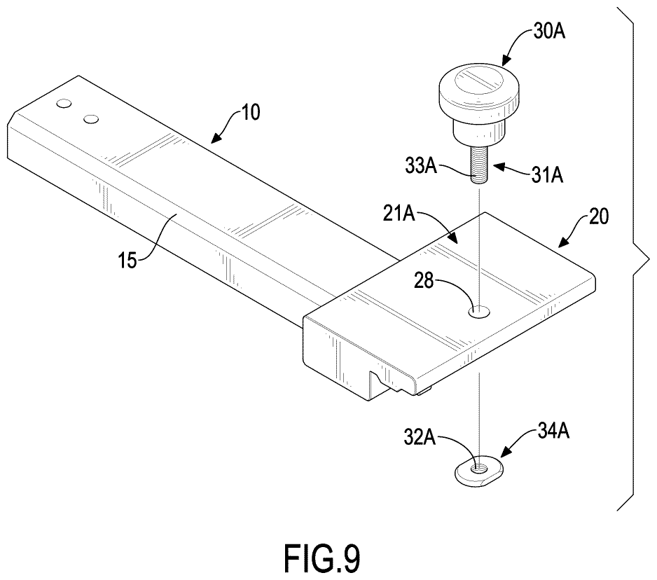

With reference to FIG. 9, a second embodiment of a vertical clamping device for circular saw machines in accordance with the present invention is substantially the same as the first embodiment as shown in FIGS. 1 to 4 except for the following features. In the second embodiment of the vertical clamping device for circular saw machines of the present invention, the threaded rod 33A of the engaging element 31A is connected to the operating button 30A, and the screw hole 32A is formed through the engaging unit 34A, and the threaded rod 33A is connected to the screw hole 32A of the engaging unit 34A by passing through the via hole 28, then the engaging unit 34A can also engage with the track 62.

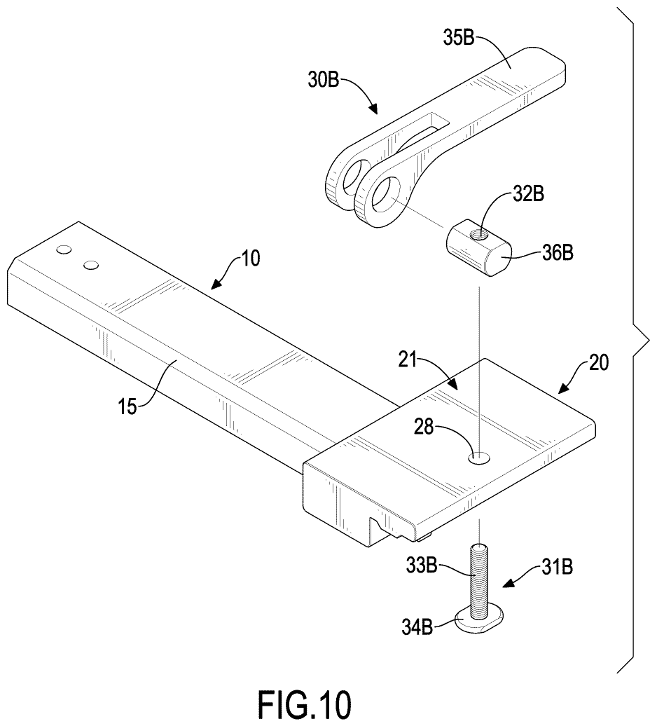

With reference to FIG. 10, a third embodiment of a vertical clamping device for circular saw machines in accordance with the present invention is substantially the same as the first embodiment as shown in FIGS. 1 to 4 except for the following features. In the third embodiment of the vertical clamping device for circular saw machines of the present invention, the operating button 30B has a stem 35B, and the stem 35B has a cam block 36B disposed on an end of the stem 35B. The screw hole 32B is formed through the cam block 36B and is connected to the threaded rod 33B of the engaging element 31B. The stem 35B is pivotally rotated relative to the connector 20 to drive the engaging unit 34B to engage with the track 62 via the cam block 36B and the threaded rod 33B.

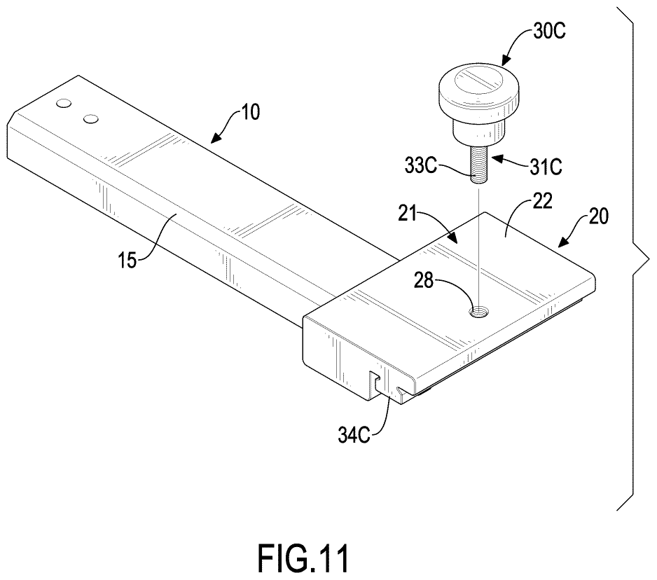

With reference to FIG. 11, a fourth embodiment of a vertical clamping device for circular saw machines in accordance with the present invention is substantially the same as the first embodiment as shown in FIGS. 1 to 4 except for the following features. In the fourth embodiment of the vertical clamping device for circular saw machines of the present invention, the engaging unit 34C of the engaging element 31C is an engaging strip and is protruded from the connecting rail 27 of the connecting block 22, and the threaded rod 33C of the engaging element 31C is connected to the engaging unit 34C by passing through the via hole 28 to enable the engaging unit 34 to engage with the track 62.

According to the above-mentioned structural relationships and features of the vertical clamping device for circular saw machines of the present invention, in use, the user only needs to put the body 10 to abut against the board 50, then the top abutting plate 11 and the side abutting plate 12 of the body 10 can respectively provide the first abutting direction D1 and the second abutting direction D2. At the same time, the connector 20 perpendicular to the body 10 is connected to the track 62 of the guide rail panel 60 to provide the third abutting direction D3. Therefore, the vertical clamping device for circular saw machines of the present invention can provide a positioning effect in three directions at the same time, which is convenient to operate and allows the circular saw machine located on the guide rail panel 60 to accurately perform vertical cutting on the board 50. In addition, through the aluminum extrusion manufacturing method of the body 10 and the connector 20 of the vertical clamping device, a vertical clamping device with accurate dimensions is provided, and also the cost of manufacturing the vertical clamping device is significantly reduced. Consequently, the vertical clamping device for circular saw machines of the present invention can be assembled conveniently, can reduce manufacturing costs, and can perform vertical cutting accurately.

Even though numerous characteristics and advantages of the present invention have been set forth in the foregoing description, together with details of the structure and features of the utility model, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A vertical clamping device for circular saw machines comprising:
a body having
a first direction extending along a length direction of the body;
a top abutting plate; and
a side abutting plate connected to a side face of the top abutting plate along the first direction such that an inner side of the side abutting plate is perpendicular to a bottom side of the top abutting plate;
a connector detachably connected to the body and having
a second direction extending along a length direction of the connector and being perpendicular to the first direction of the body;
a connecting recess formed through a bottom of the connector along a direction being parallel to the first direction of the body, mounted on an end of the body, and having an extending direction being perpendicular to the second direction of the connector; and
a connecting block disposed on a side of the connector at a side of the connecting recess away from the body, and having a connecting rail formed on and protruded from a bottom of the connecting block and extending along the second direction of the connector; and
an operating button rotatably connected to the connector and having an engaging element extending below the connecting block.

2. The vertical clamping device for circular saw machines as claimed in claim 1, wherein
the connecting block has a via hole longitudinally formed through the connecting block and the connecting rail; and
the operating button is rotatably connected to the connector at the via hole of the connecting block.

3. The vertical clamping device for circular saw machines as claimed in claim 2, wherein
the operating button has a screw hole formed therein; and
the engaging element has
a threaded rod screwed with the screw hole of the operating button via the via hole; and
an engaging unit connected to an end of the threaded rod away from the operating button and disposed below the connecting block.

4. The vertical clamping device for circular saw machines as claimed in claim 2, wherein
the operating button has a threaded rod formed in and extending out of the operating button and extending below the connecting block via the via hole; and
the engaging element is an engaging block and is connected to the threaded rod.

5. The vertical clamping device for circular saw machines as claimed in claim 2, wherein the engaging element has
an engaging unit being an engaging strip and protruded from the connecting rail of the connecting block; and
a threaded rod connected to the engaging unit by passing through the via hole.

6. The vertical clamping device for circular saw machines as claimed in claim 1, wherein
the body has two positioning faces inclinedly and respectively formed on two edges of the top abutting plate along the first direction of the body;
the connecting recess has
an opening facing the top abutting plate of the body; and
two limiting faces respectively disposed at two corners of an inner side of the connecting recess away from the opening; and
the connector is connected to the body via the connecting recess, and the two limiting faces are respectively abutted against the two positioning faces of the body to ensure that the second direction of the connector is perpendicular to the first direction of the body.

7. The vertical clamping device for circular saw machines as claimed in claim 2, wherein
the body has two positioning faces inclinedly and respectively formed on two edges of the top abutting plate along the first direction of the body;
the connecting recess has
an opening facing the top abutting plate of the body; and
two limiting faces respectively disposed at two corners of an inner side of the connecting recess away from the opening; and
the connector is connected to the body via the connecting recess, and the two limiting faces are respectively abutted against the two positioning faces of the body to ensure that the second direction of the connector is perpendicular to the first direction of the body.

8. The vertical clamping device for circular saw machines as claimed in claim 3, wherein
the body has two positioning faces inclinedly and respectively formed on two edges of the top abutting plate along the first direction of the body;
the connecting recess has
an opening facing the top abutting plate of the body; and
two limiting faces respectively disposed at two corners of an inner side of the connecting recess away from the opening; and
the connector is connected to the body via the connecting recess, and the two limiting faces are respectively abutted against the two positioning faces of the body to ensure that the second direction of the connector is perpendicular to the first direction of the body.

9. The vertical clamping device for circular saw machines as claimed in claim 4, wherein
the body has two positioning faces inclinedly and respectively formed on two edges of the top abutting plate along the first direction of the body;
the connecting recess has
an opening facing the top abutting plate of the body; and
two limiting faces respectively disposed at two corners of an inner side of the connecting recess away from the opening; and
the connector is connected to the body via the connecting recess, and the two limiting faces are respectively abutted against the two positioning faces of the body to ensure that the second direction of the connector is perpendicular to the first direction of the body.

10. The vertical clamping device for circular saw machines as claimed in claim 5, wherein
the body has two positioning faces inclinedly and respectively formed on two edges of the top abutting plate along the first direction of the body;
the connecting recess has
an opening facing the top abutting plate of the body; and
two limiting faces respectively disposed at two corners of an inner side of the connecting recess away from the opening; and
the connector is connected to the body via the connecting recess, and the two limiting faces are respectively abutted against the two positioning faces of the body to ensure that the second direction of the connector is perpendicular to the first direction of the body.

11. The vertical clamping device for circular saw machines as claimed in claim 6, wherein
the top abutting plate has at least one first through hole formed through a top side and the bottom side of the top abutting plate adjacent to one of two ends of the top abutting plate; and
the connecting recess has
at least one fixing hole formed in the inner side of the connecting recess and aligning with the at least one first through hole; and
at least one fastener connected to the at least one fixing hole via the at least one first through hole to connect the connector securely on the body.

12. The vertical clamping device for circular saw machines as claimed in claim 7, wherein
the top abutting plate has at least one first through hole formed through a top side and the bottom side of the top abutting plate adjacent to one of two ends of the top abutting plate; and
the connecting recess has
at least one fixing hole formed in the inner side of the connecting recess and aligning with the at least one first through hole; and
at least one fastener connected to the at least one fixing hole via the at least one first through hole to connect the connector securely on the body.

13. The vertical clamping device for circular saw machines as claimed in claim 8, wherein
the top abutting plate has at least one first through hole formed through a top side and the bottom side of the top abutting plate adjacent to one of two ends of the top abutting plate; and
the connecting recess has
at least one fixing hole formed in the inner side of the connecting recess and aligning with the at least one first through hole; and
at least one fastener connected to the at least one fixing hole via the at least one first through hole to connect the connector securely on the body.

14. The vertical clamping device for circular saw machines as claimed in claim 9, wherein
the top abutting plate has at least one first through hole formed through a top side and the bottom side of the top abutting plate adjacent to one of two ends of the top abutting plate; and
the connecting recess has
at least one fixing hole formed in the inner side of the connecting recess and aligning with the at least one first through hole; and
at least one fastener connected to the at least one fixing hole via the at least one first through hole to connect the connector securely on the body.

15. The vertical clamping device for circular saw machines as claimed in claim 10, wherein
the top abutting plate has at least one first through hole formed through a top side and the bottom side of the top abutting plate adjacent to one of two ends of the top abutting plate; and
the connecting recess has
at least one fixing hole formed in the inner side of the connecting recess and aligning with the at least one first through hole; and
at least one fastener connected to the at least one fixing hole via the at least one first through hole to connect the connector securely on the body.

16. The vertical clamping device for circular saw machines as claimed in claim 11, wherein
the top abutting plate has at least one second through hole formed through the top side and the bottom side of the top abutting plate adjacent to the other one of the two ends of the top abutting plate;
the at least one fixing hole of the connecting recess selectively aligns with the at least one first through hole and the at least one second through hole; and
the at least one fastener of the connecting recess is connected to the at least one fixing hole via the at least one first through hole or the at least one second through hole to connect the connector securely on the body.

17. The vertical clamping device for circular saw machines as claimed in claim 12, wherein
the top abutting plate has at least one second through hole formed through the top side and the bottom side of the top abutting plate adjacent to the other one of the two ends of the top abutting plate;
the at least one fixing hole of the connecting recess selectively aligns with the at least one first through hole and the at least one second through hole; and
the at least one fastener of the connecting recess is connected to the at least one fixing hole via the at least one first through hole or the at least one second through hole to connect the connector securely on the body.

18. The vertical clamping device for circular saw machines as claimed in claim 16, wherein
the top abutting plate has
multiple said first through holes formed through the first abutting plate at spaced intervals at one of the two ends of the first abutting plate; and
multiple said second through holes formed through the first abutting plate at spaced intervals at the other one of the two ends of the first abutting plate; and
the connector is provided with fixing holes and fasteners in the same number as the first through holes and the second through holes.

19. The vertical clamping device for circular saw machines as claimed in claim 1, wherein
the body is a strip-shaped body made by aluminum extrusion; and
the connector is a block made by aluminum extrusion.

20. The vertical clamping device for circular saw machines as claimed in claim 1, wherein the connecting rail has two guiding inclined faces respectively formed on two sides of the connecting rail along the second direction of the connector.
